(19) United States
(12) Patent Application Publication
(10) Pub. No.: US 2023/0322220 A1
(43) Pub. Date: Oct. 12, 2023

(54) PREDICTIVE TRACTION ASSIST FOR VEHICLES IN PLATOONING OPERATIONS

(71) Applicant: UT-Battelle, LLC, Oak Ridge, TN (US)

(72) Inventors: Vivek Sujan, Oak Ridge, TN (US); Jenni Muncie-Sujan, Oak Ridge, TN (US); Perry T. Jones, Oak Ridge, TN (US)

(21) Appl. No.: 18/127,290

(22) Filed: Mar. 28, 2023

Related U.S. Application Data
(60) Provisional application No. 63/328,294, filed on Apr. 7, 2022.

(51) Int. Cl. B60W 30/16; B60W 10/30; B60W 10/10; B62D 35/00; B60W 60/00; G08G 1/00; B60Q 1/50

(52) U.S. Cl. CPC B60W 30/16; B60W 10/30; B60W 10/10; B62D 35/001; B60W 60/0015; G08G 1/22; B60Q 1/507; B60Q 1/508; B60Q 1/543; B60W 2420/52; B60W 2552/20; B60W 2554/408

(57) ABSTRACT

The current embodiments include a method and a system in which a variable-configuration powertrain and trailer airbag inflation pressure can be controlled to maintain a desired following distance. By controlling a vehicle transmission, a final drive status, and/or a trailer airbag inflation pressure, a following distance can be maintained in anticipation of deceleration events to enhance vehicle deceleration capabilities. While applicable to vehicle platooning, particularly tractor trailers, the method and the system are equally applicable to essentially any autonomous following vehicle(s) which may or may not be communicatively coupled to a lead vehicle.

### CROSS-REFERENCE TO RELATED APPLICATIONS

This application claims the benefit of U.S. Provisional Application 63/328,294, filed Apr. 7, 2022, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to systems for controlling autonomous vehicle platooning, and more particular, heavy duty tractor trailer vehicle platooning.

### BACKGROUND OF THE INVENTION

With advancements in autonomous vehicles, platooning has been explored as a means for improving fuel economy resulting from reduced air resistance and reduced traffic congestion. Platooning includes a group of vehicles following each other in close proximity, with the lead vehicle being driven by a human driver or a virtual driver and the following vehicle(s) being driven by a virtual driver. Platooning tractor trailers, in particular, has received significant attention as one key pathway to fuel consumption improvement. Aerodynamic losses are a significant part of a tractor trailer's power demand. Thus, drafting or slipstreaming, where in-line vehicles reduce their overall drag, have the potential to produce appreciable fuel savings.

Adoption of this technology, with early promise, has been slow to fulfillment. This is largely attributed to the limited financial benefits that may be realized. Complexities for inter-fleet platooning arrangements (techno-economic issues), intra-fleet platooning logistics (freight planning), actual “platoon-able” roads, real-world fuel economy benefits, operator acceptance, and operational safety, are some of the challenges faced by platooning vehicle systems. In addition, platooning benefits are substantially a function of the inter-vehicle separation distance. However, a number of factors limit the minimum separation distance. These include uncertainties in vehicle mass and dynamic characteristic parameters, e.g., aero losses, rolling resistance, etc., latencies in communications between vehicles, sensing and modeling noise, capabilities of the vehicles, road traction conditions, grade, etc. Accordingly, creating pathways to reducing the safe following distance is critical to not only increasing fuel economy and reducing the carbon footprints of vehicles, but also shorter following distances will tend to mitigate cross over with other traffic.

### SUMMARY OF THE INVENTION

The current embodiments include multiple methods by which a variable-configuration powertrain and a trailer airbag inflation pressure are controlled to reduce fuel consumption while maintaining a desired following distance. By controlling a variable-configuration powertrain and/or a trailer airbag inflation pressure, a reduced following distance can be maintained in anticipation of deceleration events, while also providing greater fuel efficiency during propulsion modes. While applicable to vehicle platooning, particularly tractor trailers, the method and the system are equally applicable to essentially any autonomous following vehicle, regardless of whether the following vehicle is communicatively coupled to a lead vehicle.

In one embodiment, the system includes a hardware processor communicatively coupled to each of a transmission controller module, an axle controller module, and a trailer airbag controller module. The hardware processor is adapted to maintain a desired following distance by adjusting the transmission, adjusting a final drive status or gearing, and/or by adjusting the trailer airbag inflation pressure. When adjusting the transmission, the transmission controller module can cause the transmission to upshift, downshift, or shift to neutral. When adjusting the final drive status, the axle controller module can cause the final drive to switch between engaged and disengaged and/or can vary the gear ratio of the final drive, if applicable. When adjusting the trailer airbag inflation pressure, the trailer airbag controller module can vary the height of all or a portion of the trailer to change aerodynamic drag forces on the trailer.

As discussed herein, each of the foregoing systems (transmission gearing, the final drive status/gearing, and the trailer airbag pressure) can directly influence the ability of the vehicle brakes to act in an effective way. These systems tradeoff propulsion efficiency for deceleration. Under normal driving conditions, the foregoing systems can return to their fuel economy optimized states. In addition, look-ahead route information can enhance the ability of platooning vehicles to maintain a desired following distance during decelerations and accelerations. While useful to non-platooning vehicles over rolling terrain, control of the aforementioned systems is also important for platooning vehicles that are actively trying to maintain a shortened separation distance.

In another embodiment, the present invention includes visual indicators that indicate the host vehicle is part of a vehicle platoon. The visual indictors can include for example a specific sequence of blinking lights or colored lights. One or more of the platooning vehicles, for example the lead vehicle, can initiate a command sequence to ensure that the visual indicators shared by each of the platooning vehicles blink in a synchronized manner. The visual indicators can indicate the status of a vehicle in the platoon, for example whether the vehicle is entering the platoon, exiting the platoon, or overtaking another vehicle in the platoon. The visual indicators can be extended to non-platooning operations as well. For example, the visual indicators can indicate the level of active automation and may preview a drop in active automation. Additional embodiments include deploying mechanical features, for example aerodynamic fairings, when platooning and/or broadcasting critical information to nearby vehicles when platooning.

These and other features and advantages of the present invention will become apparent from the following description of the invention, when viewed in accordance with the accompanying drawings and appended claims.

Before embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 illustrates a system of platooning vehicles, for example tractor trailers, including a lead vehicle and at least one follower vehicle.

FIG. 2 illustrates a block diagram of a system having a processor for controlling operation of a follower vehicle.

FIG. 3 illustrates a transmission for a tractor trailer having an internal combustion engine or an electric motor.

FIG. 4 illustrates a 6×4 tractor trailer having an adjustable final drive status based on a measured following distance.

FIG. 5 illustrates a tractor trailer having an adjustable trailer ride height and angle based on a measured following distance.

FIG. 6 is a flow diagram illustrating a method for maintaining a following distance by controlling a vehicle transmission.

FIG. 7 is a flow diagram illustrating a method for maintaining a following distance by controlling a final drive status.

FIG. 8 is a flow diagram illustrating a method for maintaining a following distance by controlling a trailer air bag inflation pressure.

FIG. 9 is a flow diagram illustrating a method for maintaining a following distance by controlling a vehicle transmission, a final drive status, and/or a trailer airbag inflation pressure.

FIG. 10 is a flow diagram illustrating a method for maintaining a following distance based on dynamic and static route information.

FIG. 11 illustrates a system of platooning vehicles including coordinated lights, deployable mechanical structures, and a critical information broadcast.

FIG. 12 illustrates a system of platooning vehicles including deployable fairings, deployable arms, and coordinated lights.

### DETAILED DESCRIPTION OF THE CURRENT EMBODIMENTS

The current embodiments include a method and a system in which a variable-configuration transmission, final drive, and/or trailer airbag inflation pressure can be controlled to help maintain a shortened following distance. By controlling the vehicle transmission, final drive, and/or trailer airbag inflation pressure, a following distance can be maintained in anticipation of deceleration events and during propulsion modes of operation. The method and the system are primarily described below in relation to vehicle platooning, particularly for platooning tractor trailers, however the method and the system are equally applicable to essentially any autonomous following vehicle(s) which may or may not be communicatively coupled to a lead vehicle.

Nominally, a platoon is configured to minimize fuel consumption. This includes not only separation distances but also the configurations of the trailing vehicle powertrain to minimize road load. Following vehicles are generally required to maintain a safe following distance and must do so in the most effective way, e.g., including control latencies, wear and tear to service brakes, and drivability. Appropriately reconfiguring the powertrain and/or chassis elements in anticipation of a deceleration event helps by allowing the powertrain to support deceleration and by increasing the road load, which also supports deceleration. Deceleration may also be needed based on traffic conditions, speed limits, construction zones, geofences, weather conditions, road grade, road surface conditions, or other quantifiable parameters.

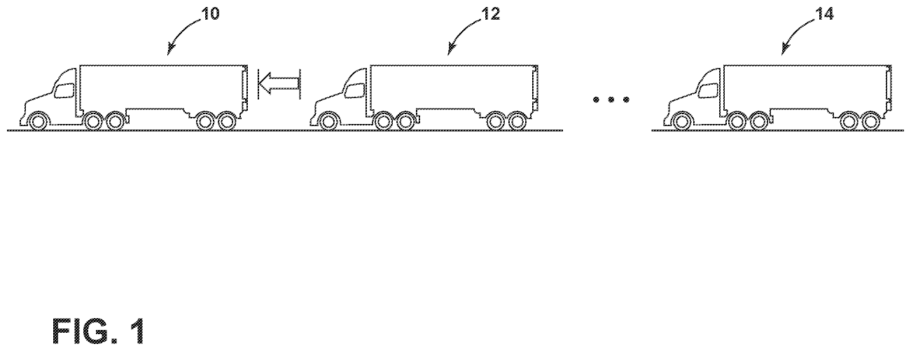

Referring now to FIG. 1, a system of platooning tractor trailers is illustrated. The system includes a lead vehicle 10 and multiple following vehicles 12, 14. In some embodiments, the vehicles 10, 12, 14 are communicatively coupled to each other, such that any one vehicle in the platoon can transmit data to another vehicle in the platoon. The data can include, by non-limiting example, whether the vehicle is platooning or is available to platoon, whether the vehicle is autonomous (i.e., capable of SAE Level 4 autonomous travel), the remaining fuel on-board the vehicle, and the intended route and destination for the vehicle. Direct communication between the two or more vehicles can occur wirelessly according to any desired protocol, including for example Dedicated Short Range Communications (DSCR). Other communication protocols are also possible for inter-vehicle communications, whether now known or later developed.

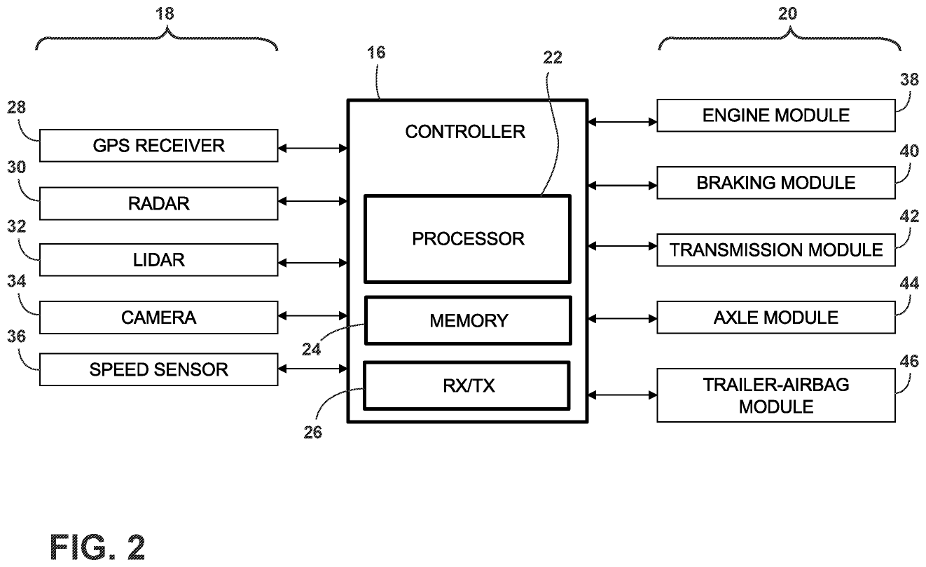

Referring now to FIG. 2, a vehicle control architecture that is suitable for use with platooning or non-platooning vehicles is illustrated. The vehicle control architecture includes a platooning controller 16 that receives inputs from a number of sensors 18 and a number of control modules 20. The platooning controller 16 includes a processor 22, an internal memory 24, and inter-vehicle communications module 26 to process communications among the lead vehicle and other following vehicles. By non-limiting example, some of the sensors 18 include a GPS receiver 28, a radar module 30, a LIDAR module 32, camera-based sensors 34, and wheel speed sensors 36. The foregoing list of sensors is not exclusive, and other sensors can be included in other embodiments, including for example an accelerator pedal position sensor, a brake pedal position sensor, and an internal navigation system having one or more accelerometers and/or gyroscopes.

As also shown in FIG. 2, the vehicle control architecture includes multiple control modules 20 that are configured to control operation of the tractor's powertrain, the trailer's airbag pressure, and/or other vehicle systems. In the illustrated embodiment, the control modules 20 include at least the following: an engine control module 38, a braking control module 40, a transmission control module 42, an axle control module 44, and a trailer airbag control module 46. As noted above, each of the platooning vehicles is configured for mutually communicating signals and exchanging data with each other. The platooning vehicles are also configured for communicating and exchanging data remotely. The data acquired remotely can include static information and dynamic information, each pertaining to the intended route of travel. Static information can include road grade and speed limits, and dynamic information can include traffic density, weather conditions, road surface conditions, and other temporal road anomalies.

As discussed below, if the platooning controller 16 determines that the vehicle needs a net negative output power from the wheels, for example when decelerating or when maintaining speed during a decline, it can reconfigure one or more of the transmission gearing, the final drive status or gearing, and the trailer airbag pressure. Similarly, if the platooning controller 16 determines that the vehicle needs a net positive output power from the wheels, for example when accelerating or when maintaining speed during an incline, it can reconfigure one or more of the transmission gearing, the final drive status or gearing, and the trailer airbag pressure. In each instance, the controller 16 determines the appropriate combination of control outputs by balancing the responsiveness, effectiveness, and energy costs of the available control outputs.

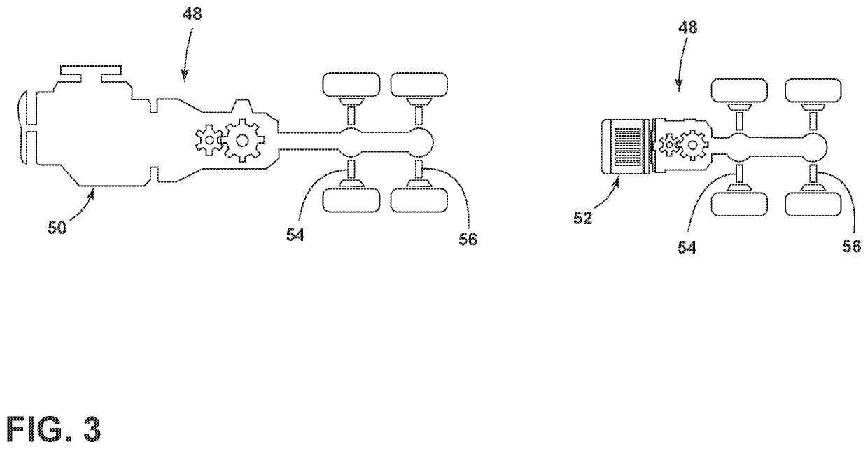

As shown in FIG. 3, for example, the selected transmission gear impacts the engine speed and the corresponding amount of engine brake power available. The transmission controller module 42 is configured to adjust the transmission 48 between two of downshift, neutral, and upshift. The transmission 48 can be coupled to an internal combustion engine 50 in some embodiments, while in other embodiments the transmission 48 can be coupled to an electric motor 52. By downshifting during a deceleration event, the transmission controller module 42 can reduce or minimize the negative power demand required of the braking system(s) while maintaining a desired following distance. By upshifting after the deceleration event, the transmission controller module 42 can return the powertrain to an optimum configuration for maintaining a desired following distance.

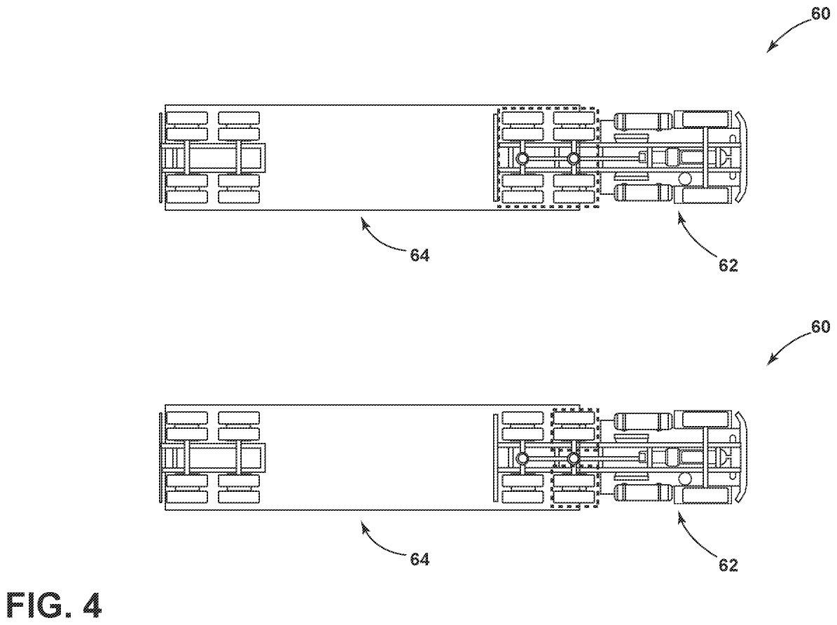

As noted above, the platooning controller 16 can also cause the axle control module 44 to change the final drive status of a following vehicle. In many modern tractor trailers, the transmission turns a drive shaft, which is coupled to a final drive, and the final drive turns the driven axle(s). The final drive allows the forward and rear axles to turn independently of each other. When the final drive is “engaged,” the final drive transmits power equally to both axles. When the final drive is “dis-engaged,” the final drive transmits power unevenly as between the two axles or transmits power exclusively to one axle. As illustrated in FIG. 4 for example, the final drive can alternate between a 6×4 chassis configuration (power to tandem rear axles) and a 6×2 chassis configuration (power to just one rear axle). The final drive can also include a variable gear ratio, such that two or more gear ratios are available between the drive shaft and the driven axle. The gearing ratio for the final drive can be controlled in the same manner as described above in connection with transmission gearing during deceleration events.

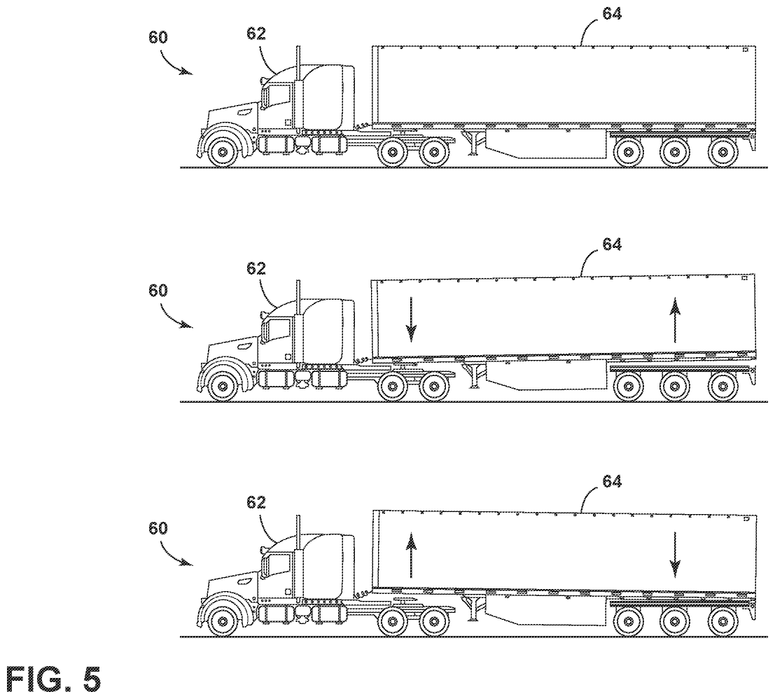

The platooning controller 16 can also cause the trailer airbag module 46 to vary the pressure in one or more airbags in a trailer suspension system. While conventionally used to control the trailer ride height, the trailer airbags can be controlled for varying the aerodynamic drag forces on the trailer. With reference to FIG. 5, for example, a tractor trailer 60 having a tractor 62 and a trailer 64 is illustrated. By increasing the air pressure in the rear airbags and/or decreasing the air pressure in the front airbags, the front of the trailer 64 is lowered, lessening the cross-sectional area of the trailer 64 in the forward wind stream. Conversely, by decreasing the pressure in the rear airbags and/or increasing the pressure in the front airbags, the front of the trailer 64 is raised, increasing the cross-sectional area of the trailer 64 in the forward wind stream, and thereby potentially aiding in slowing the tractor trailer 60 during a braking event.

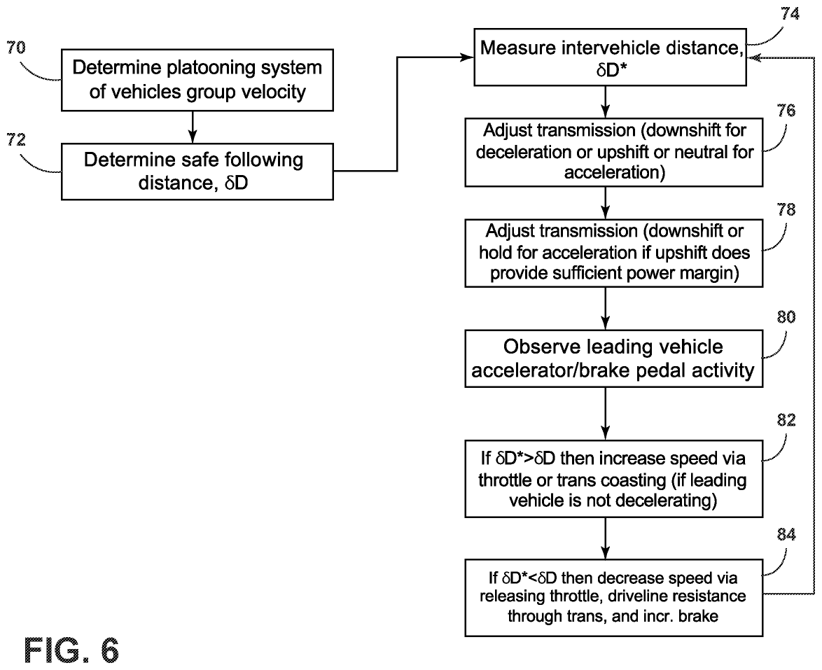

Referring now to FIG. 6, a first flow chart for a method of controlling a platooning vehicle and/or a following vehicle is illustrated. The method includes determining the group velocity of the vehicle platoon and/or a lead vehicle at step 70 and, using that group velocity, determining a safe following distance δD at step 72. The safe following distance δD can be determined by the platooning processor 22 according to any suitable method. For example, the safe following distance δD can be based on a variety of factors, including but not limited to road surface conditions, air-brake lag time, vehicle speed, vehicle weight, and aerodynamic drag. At step 74, the platooning processor 22 determines the measured inter-vehicle distance δD*, that is, the spacing between the following vehicle and the immediately preceding vehicle in the platoon (which may nor may not be the lead vehicle). The measured inter-vehicle distance δD* can be determined based on the output of one or more sensors, including for example the radar module 30, the LIDAR module 32, and/or the camera-based sensors 34. At step 76, the method includes adjusting the transmission 48. This can include downshifting to aid the tractor trailer in decelerating or upshifting or switching to neutral to aid the tractor trailer in accelerating while traversing a negative incline. At step 78, if upshifting does not provide sufficient power margin, the method includes downshifting the transmission. The method then includes observing the lead vehicle accelerator and brake pedal activity at step 80, optionally over the inter-vehicle communications link, to anticipate potential acceleration or deceleration events. If the measured inter-vehicle distance δD* is greater than the safe following distance δD, the method includes increasing the speed of the following vehicle via the engine control module 38 at step 82. If however the measured inter-vehicle distance δD* is less than the safe following distance δD, the method includes decreasing the speed of the following vehicle via the engine control module 38 (releasing the throttle), downshifting the transmission, and/or incremental braking of the tractor trailer's air brakes at step 84. The method then reverts to step 74 for the continued measurement of the inter-vehicle distance δD* as a continuous control loop.

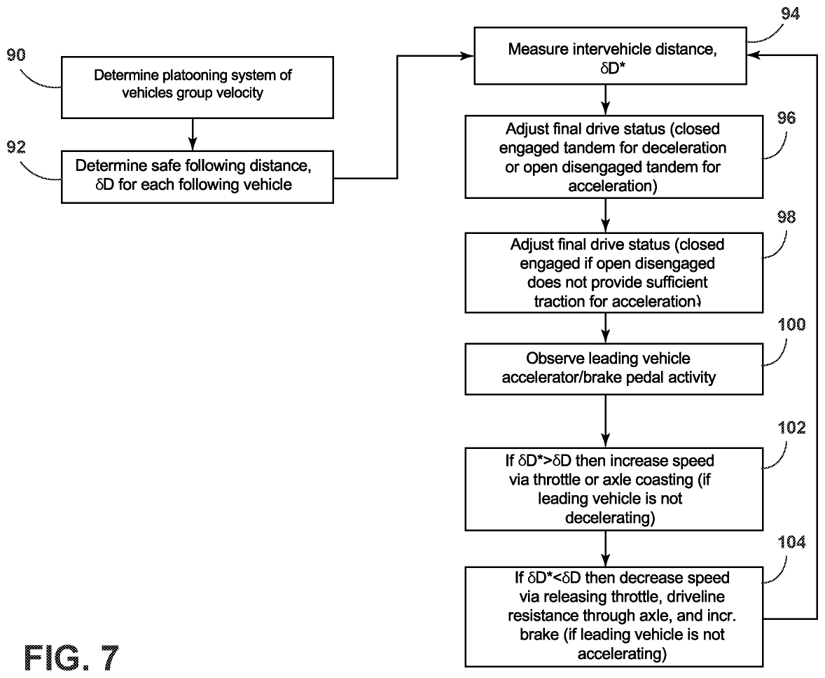

Referring now to FIG. 7, a second flow chart for a method of controlling a platooning vehicle and/or a following vehicle is illustrated. This method differs from the method of FIG. 6 in that the method of FIG. 7 includes adjusting a final drive status (including an associated final drive gearing, if available) in place of a transmission gearing. More specifically, the method of FIG. 7 includes determining the group velocity of the vehicle platoon and/or a leading vehicle at step 90 and, using that group velocity, determining a safe following distance δD at step 92. At step 94, the platooning processor 22 determines the measured inter-vehicle distance δD* based on the output of one or more sensors 18, including for example the radar module 30, the LIDAR module 32, and/or the camera-based sensors 34. At step 96, the method includes adjusting the final drive status (closed-engaged v. open-disengaged) and/or the final drive gear ratio (if a variable ratio final drive is provided). This step can include a closed-engaged tandem for deceleration (e.g., 6×4) or an open-disengaged tandem for acceleration (e.g., 6×2). If a variable ratio final drive is provided, this step can also include downshifting to a higher gear ratio to aid the tractor trailer in decelerating or upshifting to a lower gear ratio to aid the tractor trailer in accelerating. At step 98, if open-disengaged does not provide sufficient traction, the method includes adjusting the final drive status to closed-engaged. The method then includes observing the lead vehicle accelerator and brake pedal activity at step 100, optionally over the inter-vehicle communications link, to anticipate potential acceleration or deceleration events. If the measured inter-vehicle distance δD* is greater than the safe following distance δD, the method includes increasing the speed of the following vehicle via the engine control module 38 at step 102 or axle coasting if the lead vehicle is not decelerating. If however the measured inter-vehicle distance δD* is less than the safe following distance δD, the method includes decreasing the speed of the following vehicle via the engine control module 38 (releasing the throttle) and/or incremental braking of the tractor trailer's air brakes at step 104. The method then reverts to step 94 for the continued measurement of the inter-vehicle distance δD* as a continuous control loop.

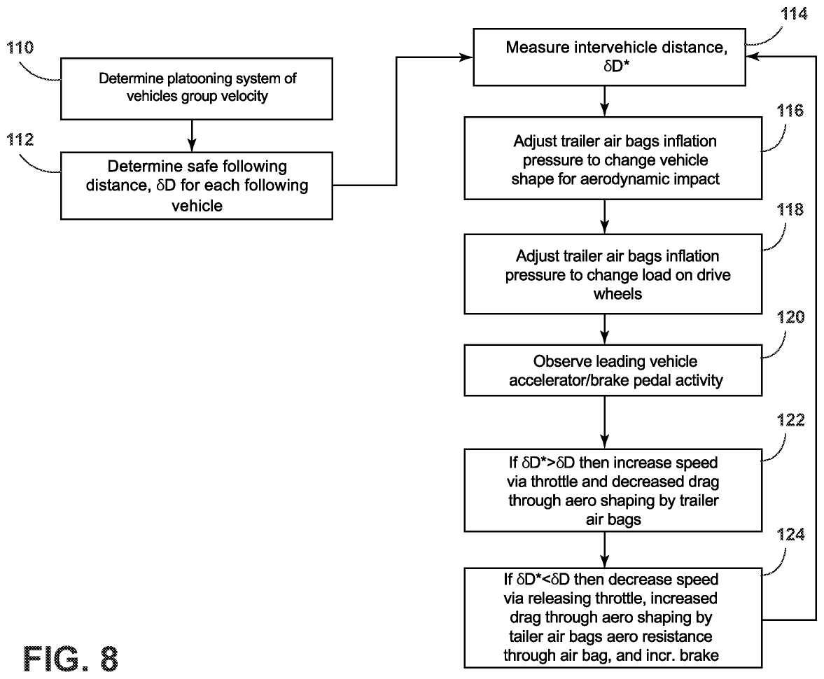

Referring now to FIG. 8, a third flow chart for a method of controlling a platooning vehicle and/or a following vehicle is illustrated. This method differs from the methods of FIGS. 6-7 in that the method of FIG. 8 includes adjusting a trailer airbag inflation pressure in place of a transmission gearing. More specifically, the method of FIG. 8 includes determining the group velocity of the vehicle platoon and/or a leading vehicle at step 110 and, using that group velocity, determining a safe following distance δD at step 112. At step 114, the platooning processor 22 determines the measured inter-vehicle distance δD* based on the output of one or more sensors 18, including for example the radar module 30, the LIDAR module 32, and/or the camera-based sensors 34. At steps 116 and 118, the method includes adjusting the trailer airbag inflation pressure. Adjusting the inflation pressure can change the aerodynamic drag on the trailer at step 116 and/or change the load on the drive wheels at step 118. For example, the aerodynamic drag of the trailer can be increased (decreased) by raising (lowering) the air pressure in the front trailer airbags. Also by example, the load on the drive wheels can be increased (decreased) by lowering (raising) the air pressure in the front trailer airbags to aid in decelerating. The method then includes observing the lead vehicle accelerator and brake pedal activity at step 120, optionally over the inter-vehicle communications link, to anticipate potential acceleration or deceleration events. If the measured inter-vehicle distance δD* is greater than the safe following distance δD, the method includes increasing the speed of the following vehicle via the engine control module 38 at step 122 and/or decreasing the aerodynamic drag of the trailer through control of the trailer airbags. If however the measured inter-vehicle distance δD* is less than the safe following distance δD, the method includes decreasing the speed of the following vehicle via the engine control module 38 (releasing the throttle), increasing the aerodynamic drag of the trailer through control of the trailer airbags and/or incremental braking of the tractor trailer's air brakes at step 124. The method then reverts to step 114 for the continued measurement of the inter-vehicle distance δD* as a continuous control loop.

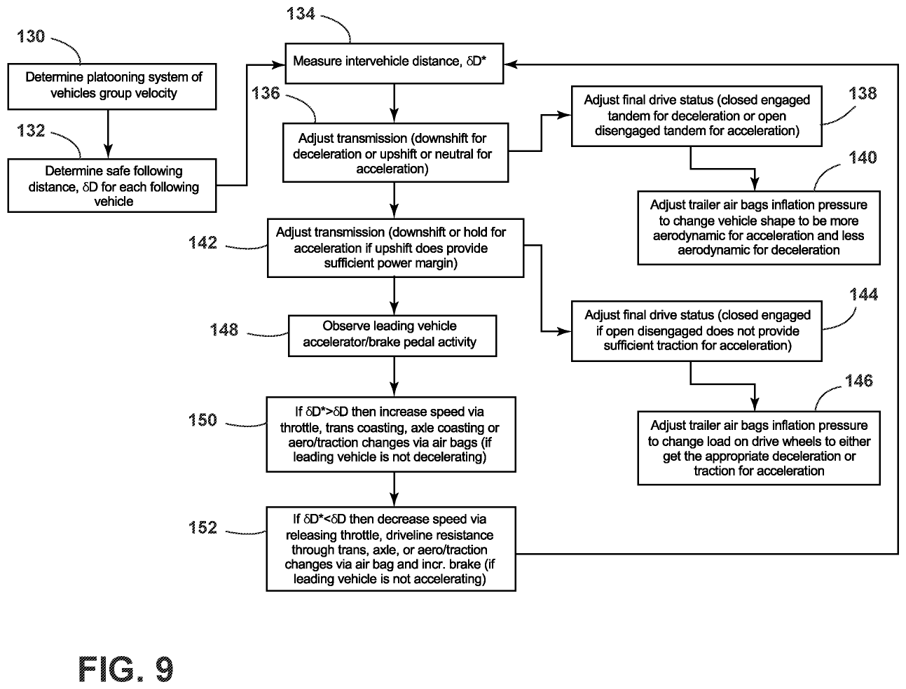

Referring now to FIG. 9, a fourth flow chart illustrates a method of controlling a platooning vehicle and/or a following vehicle. This method is essentially a combination of the method of FIGS. 6-8, in that the processor 22 controls one or more of the following control modules during travel: the transmission control module 42, the axle control module 44, and the trailer airbag control module 46. More particularly, the method of FIG. 9 includes determining the group velocity of the vehicle platoon and/or a leading vehicle at step 130 and, using that group velocity, determining a safe following distance δD at step 132. At step 134, the platooning processor 22 determines the measured inter-vehicle distance δD* based on the output of one or more sensors 18, including for example the radar module 30, the LIDAR module 32, and/or the camera-based sensors 34. At steps 136, 138, and 140, the processor 22 causes the appropriate module 42, 44, 46 to adjust as needed to aid in the deceleration or the acceleration of the tractor trailer. To aid in deceleration, for example, the transmission control module 42 can cause the transmission to downshift while the axle control module 44 adjusts the final drive status to closed-engaged and the trailer airbag control module 46 adjusts the trailer airbag pressure to increase the aerodynamic drag of the trailer. To aid in acceleration, by contrast, the transmission control module 42 can cause the transmission to upshift (or switch to neutral if coasting) while the axle control module 44 adjusts the final drive status to open-disengaged and the trailer airbag control module 46 adjusts the trailer airbag pressure to decrease the aerodynamic drag of the trailer.

At steps 142, 144, and 146, the processor 22 causes the appropriate module 42, 44, 46 to adjust as needed to aid in the deceleration or the acceleration of the tractor trailer. At step 142 for example, the processor 22 causes the transmission control module 42 to downshift or hold for acceleration if the upshift of step 136 does not provide sufficient power margin. At step 144, the processor 22 causes the axle control module 44 to adjust to a closed-engaged final drive status if the open-disengaged final drive status of step 138 does not provide sufficient traction for acceleration. At step 146, the trailer airbag control module 46 adjusts the trailer airbag inflation pressure to change in the load on the drive wheels (by shifting the trailer center of gravity forward or rearward) to achieve the desired deceleration or traction for acceleration. The method then includes observing the lead vehicle accelerator/brake pedal activity at step 148, optionally over the inter-vehicle communications link. If the measured inter-vehicle distance δD* is greater than the safe following distance δD, step 150 includes increasing the speed of the following vehicle via the engine control module 38, trans coasting, axle coasting, and/or decreasing the aerodynamic drag of the trailer through control of the trailer airbags. If however the measured inter-vehicle distance δD* is less than the safe following distance δD, step 152 includes decreasing the speed of the following vehicle via the engine control module 38 (releasing the throttle), increasing the driveline resistance via the transmission control module 42 and/or the axle control module 44, increasing the aerodynamic drag of the trailer through control of the trailer airbags, and/or incremental braking of the tractor trailer's air brakes at step 152. The method then reverts to step 134 for the continued measurement of the inter-vehicle distance δD* as a continuous control loop.

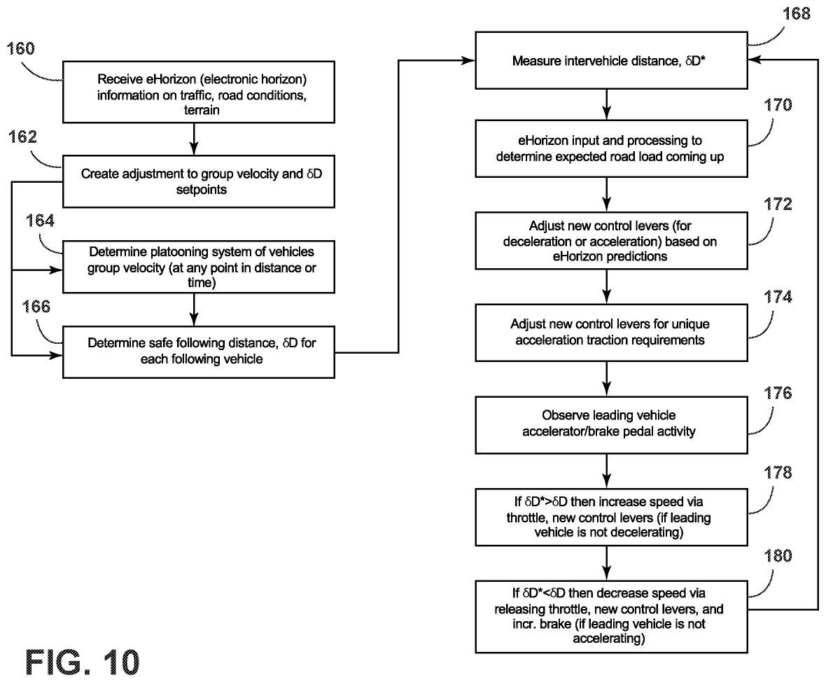

Referring now to FIG. 10, a flow-chart for integrating the use of route information to the foregoing system and method is illustrated. At step 160, the processor 22 receives real-time or near real-time route information, including static route information and dynamic route information. The static route information can include road grade, road surface type, and speed limits, and the dynamic route information can include traffic density, road surface conditions, weather conditions, and other temporal road anomalies. At step 162, the method includes adjusting the group velocity and the safe following distance δD setpoints based on the route information made available to the processor 22. At step 164, the method includes determining the group velocity of the vehicle platoon and/or a leading vehicle and, using that group velocity and the route information, determining a safe following distance δD at step 166. At step 168, the processor 22 determines the measured inter-vehicle distance δD* based on the output of one or more sensors 18, including for example the radar module 30, the LIDAR module 32, and/or the camera-based sensors 34. At step 170, the method includes determining the future road load based on available route information for a corresponding section of the vehicle's route. At step 172, the method includes adjusting one or more of transmission gearing, final drive status/gearing, and trailer airbag pressure based on the road load determined at step 170. At step 174, the method then includes adjusting one or more of transmission gearing, final drive status/gearing, and trailer airbag pressure to meet the acceleration requirements of the following vehicle, if needed.

The method then includes observing the lead vehicle accelerator/brake pedal activity at step 176, optionally over the inter-vehicle communications link, to anticipate potential acceleration or deceleration events. If the measured inter-vehicle distance δD* is greater than the safe following distance δD and the lead vehicle is not decelerating, the method includes increasing the speed of the following vehicle via the engine control module 38 at step 178 and/or adjusting one or more of the transmission gearing, final drive status/gearing, and trailer airbag pressure. If however the measured inter-vehicle distance δD* is less than the safe following distance δD, the method includes decreasing the speed of the following vehicle via the engine control module 38 (releasing the throttle), and/or adjusting one or more of the transmission gearing, final drive status/gearing, and trailer airbag pressure at step 180. The method then reverts to step 168 for the continued measurement of the inter-vehicle distance δD* as a continuous control loop.

In these and other embodiments, the controller 16 includes machine readable instructions stored to memory 24 that, when executed, cause the processor 22 to carry out the methods described above in connection with the flow charts of FIGS. 6-10. The processor 22 can comprise digital circuitry, analog circuitry, or a combination of digital circuitry and analog circuitry. The controller 16 can ultimately cause the following vehicle to adopt a reduced following distance with respect to the immediately preceding vehicle to take advantage of a wind break tunnel and to increase fuel economy. The controller 16 can also configure the transmission gearing, final drive status/gearing, and trailer airbag pressure to meet acceleration requirements when overtaking a preceding vehicle, for example the lead vehicle, and to meet deceleration requirements once the overtaking maneuver is completed. As the lead vehicle, the controller 16 can cause the lead vehicle to slow to allow following vehicles to close the gap with the lead vehicle, in the same manner as described above when slowing the following vehicle. Once the desired gap distance is achieved, both vehicles can accelerate, so that both vehicles return to the desired platooning speed. With manipulation of the transmission gearing, final drive status/gearing, and trailer airbag pressure, each vehicle can reach the desired platooning speed more quickly.

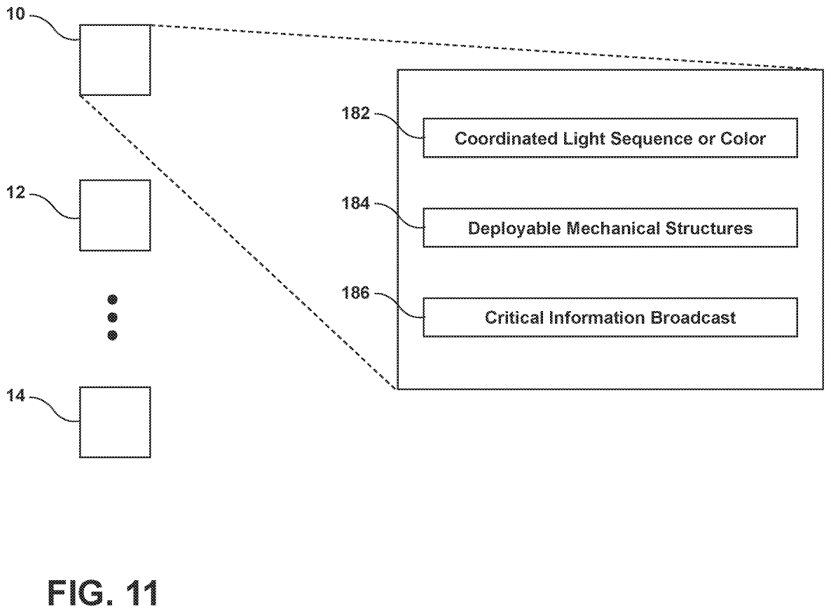

In a further aspect, the present invention includes visual indicators that indicate the host vehicle is part of a vehicle platoon. As shown in FIG. 11 for example, each vehicle 10, 12, 14 in a platoon can include visual indictors 182, for example a specific sequence of blinking lights or colored lights on the tractor and/or the trailer. One or more of the platooning vehicles, for example the lead vehicle, can initiate a command sequence to ensure that the visual indicators 182 shared by each of the platooning vehicles blink in a synchronized manner and/or a synchronized color. The visual indicators can indicate the status of a vehicle in the platoon, for example whether the vehicle is entering the platoon, exiting the platoon, or overtaking another vehicle in the platoon. The visual indicators 182 can be extended to non-platooning operations as well. For example, the visual indicators can indicate the level of active automation and may preview a drop in active automation (e.g., SAE level 4 active automation to SAE level 3 active automation).

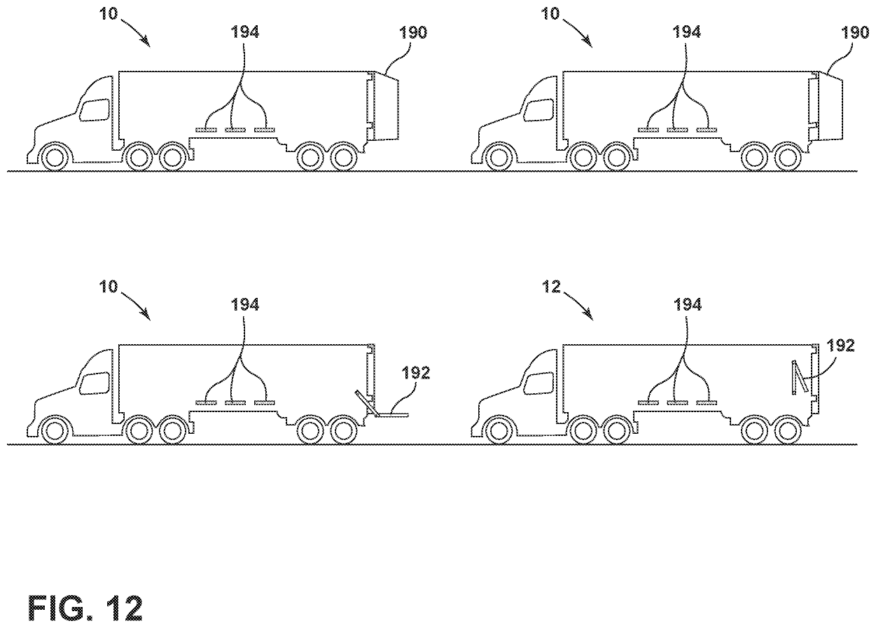

Additional embodiments include deploying mechanical features 184, for example deployable arms or aerodynamic fairings, when platooning and/or broadcasting critical information to nearby vehicles when platooning. For example, the mechanical features 184 can indicate to other vehicular traffic that the host vehicle is part of a vehicle platoon. The mechanical features 184 can also or alternatively improve the collective aerodynamic performance of the platoon. As shown in FIG. 12, for example, the mechanical features 184 can comprise trailer fairings 190 that extend under high speeds when part of a vehicle platoon to create the desired aerodynamic slip stream between platooning vehicles. As also shown in FIG. 12, the mechanical features 184 can comprise retractable arms 192 that prevent vehicular traffic from entering the gap between platooning vehicles. While shown as extending from the lead vehicle in FIG. 12, the mechanical features can also or alternatively extend from the following vehicle toward the lead vehicle. Sequenced or colored lights 194 are also shown in FIG. 12, which as noted above can visually indicate the status of each of the vehicles within the platoon.

As a further aspect, the present invention can include the broadcast of platoon status information 186 according to any desired protocol, including for example DSCR. The platoon status information 186 can include one or more of the following data fields for each vehicle in the platoon: vehicle identification number (VIN), vehicle license plate number, vehicle GPS location, vehicle heading, vehicle speed, vehicle trailer height, and vehicle weight. The platoon status information 186 can also or alternatively include one or more of the following data fields pertaining the platoon itself: location of the platoon, heading of the platoon, average speed of the platoon, average inter-vehicle separation distance, number of vehicles in the platoon, average propulsive power of the platoon, current route of the platoon, current health of the platoon (e.g., the presence or absence of fault codes, the status of each vehicles' braking system). The foregoing information may be broadcast to potential stakeholders, for example nearby commercial vehicles and/or highway police, and may also be broadcast to a remote vehicle fleet management server. The foregoing information can then be presented to other drivers via a mobile application or via one or more heads up displays.

The described technologies can be used generally in the fields of transportation, energy, and utilities. More specifically, the described technologies pertain to all commercial class vehicles that are substantially operated on highways, e.g., Class 8 line haul. Other following vehicles, e.g., passenger vehicles, can make use of the methods described above, particularly when operating in an autonomous driving mode, regardless of whether the vehicle is platooning.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A system for operating a follower vehicle traveling in relation to a lead vehicle, the system comprising:
a hardware processor communicatively coupled to a group of controller modules of the follower vehicle, wherein the group of controller modules comprises one or more of a transmission controller module, an axle controller module, or a trailer airbag controller module, wherein the hardware processor is configured to:
obtain a following range, an instant-following distance, and lead-vehicle state information indicative of whether the lead vehicle is decelerating or accelerating,
determine whether the instant-following distance is outside of the following range, and if so, cause the instant-following distance to return within the following range by instructing, based at least in part on the leading-vehicle state information, one or more of:
the transmission controller module to adjust a transmission between two of downshift, neutral, and upshift,
the axle controller module to adjust final drive status between engaged and disengaged or to adjust a final drive gear ratio, or
the trailer airbag controller module to adjust airbag inflation pressure to change the height of the follower vehicle between more aerodynamic and less aerodynamic.

2. The system of claim 1, wherein the hardware processor is configured to produce adjustment instructions for one or more of the transmission controller module, the axle controller module, or the trailer airbag controller module that maximize a resulting performance at least in terms of minimizing fuel consumption.

3. The system of claim 1, wherein the hardware processor is configured to produce adjustment instructions for two or more of the transmission controller module, the axle controller module, or the trailer airbag controller module.

4. The system of claim 1, wherein the hardware processor is configured to produce adjustment instructions for the transmission controller module.

5. The system of claim 1, wherein the hardware processor is configured to produce adjustment instructions for the axle controller module.

6. The system of claim 1, wherein the hardware processor is configured to produce adjustment instructions for the trailer airbag controller module.

7. The system of claim 1, comprising a means for measuring a following distance that is located on the follower vehicle, wherein the hardware processor is configured to obtain the instant-following distance from the following-distance measuring means.

8. The system of claim 7, wherein the following-distance measuring means comprises a radar-based measurement system.

9. The system of claim 1, wherein the hardware processor is a first hardware processor and is located on the follower vehicle and is communicatively coupled with a second hardware processor located on the lead vehicle, and wherein the first hardware processor is configured to obtain at least the lead-vehicle state information from the second hardware processor.

10. The system of claim 1, wherein the hardware processor is configured to:
receive planning information comprising at least upcoming road profile and traffic conditions,
determine the following range based at least in part on the planning information, and
produce adjustment instructions for the one or more of the transmission controller module, the axle controller module, or the trailer airbag controller module based on the planning information.

11. A platoon comprising:
two or more vehicles forming at least one pair of lead-follower vehicles, wherein the at least one pair of lead-follower vehicles is operated using the system of claim 1.

12. The platoon of claim 11, wherein the two or more vehicles include internal combustion vehicles.

13. The platoon of claim 11, wherein the two or more vehicles includes at least one vehicle having an internal combustion engine and at least one vehicle having other propulsion systems.

14. The platoon of claim 11, wherein the two or more vehicles includes at least one autonomous vehicle.

15. The platoon of claim 11, wherein each of the two or more vehicles is configured to produce a sequence of blinking lights or color in coordination with each other to indicate a status of each of the vehicles within the platoon.

16. The platoon of claim 11, wherein each of the two or more vehicles comprises one or more mechanical structures configured to be extended from the vehicle in coordination with other vehicles of the platoon to indicate a status of the vehicles within the platoon.

17. The platoon of claim 16, wherein the mechanical structures are configured to act, when extended, as aerodynamic features to aerodynamically couple with corresponding aerodynamic features of other of the two or more vehicles in the platoon.

18. The platoon of claim 16, wherein the status comprises one of:
joining the platoon,
being part of the platoon,
changing order within the platoon, or
exiting the platoon.

19. The platoon of claim 11, wherein at least one of the two or more vehicles is configured to broadcast critical information associated with the platoon.

20. The platoon of claim 19, wherein the broadcast comprises communication of the critical information associated with the platoon over a public communications network.

21. The platoon of claim 20, wherein the communication comprises publication of the critical information associated with the platoon through a mobile phone application or a web page.

22. The platoon of claim 19, wherein the critical information includes one or more of:
vehicle license plate number or VIN of one or more of the vehicles of the platoon,
location of the platoon,
heading of the platoon,
route of the platoon,
group velocity of the platoon,
group mass of the platoon,
a group statistic of inter-vehicle separation distance within the platoon,
a group statistic of propulsion power of powertrains within the platoon,
a group statistic of increase in fuel economy for the vehicles of the platoon,
health of the platoon based on particular component capabilities for the vehicles of the platoon,
number of vehicles in the platoon, or
last vehicle expected distance till break-away from the platoon.

23. The platoon of claim 22, wherein the group statistic is one of:
an average,
a median,
a minimum, or
a maximum.
